(19) United States
(12) Patent Application Publication
(10) Pub. No.: US 2005/0207872 A1
(43) Pub. Date: Sep. 22, 2005

(54) Electronic lift interface using linear variable differential transducers

(75) Inventors: Michael K. Taylor, Marion, NY (US); Mark F. Scholand, Spencerport, NY (US)

Correspondence Address: BASCH & NICKERSON LLP, 1777 PENFIELD ROAD, PENFIELD, NY, 14526, US

(73) Assignee: Gorbel, Inc., Fishers, NY (US)

(21) Appl. No.: 11/085,764

(22) Filed: Mar. 21, 2005

Related U.S. Application Data
(60) Provisional application No. 60/555,178, filed on Mar. 22, 2004.

(51) Int. Cl. B25J 1/00

(52) U.S. Cl. 414/1

(57) ABSTRACT

Disclosed is a method and apparatus to provide a pendant or operator interface for controlling a variable velocity cable lift. In particular, the present invention is intended for use with an electrically-actuated cable lift, and simulating the performance of a pneumatic or similar lift mechanism. The invention is directed to the control handle or interface for such a system, which employs a variable displacement transducer as a substitute for a force-sensing handle.

Priority is claimed from U.S. Provisional Application No. 60/555,178, filed Mar. 22, 2004, which is hereby incorporated by reference in its entirety.

The present invention is directed to an improved pendant or operator interface for a variable velocity lift and more particularly for use with an electrically-actuated cable lift, with the ability to simulate the performance of a pneumatic or similar lift mechanism.

### BACKGROUND AND SUMMARY

The present invention is directed to a control mechanism(s) and method for a lift system, in one embodiment a system that employs variable differential transducers as a substitute for a force-sensing handle such as is presently sold in association with a G-Force lift by Gorbel, Inc.

The system and method disclosed find practical application in particular work environments where the end-effector (the means for picking up the intended load) is moved by an operator to assist in the alignment, placement or positioning of the load—either before, during or after being picked up by the lift. For example, the end-effector may be a clamping mechanism for enclosing and picking up a part such as a wheel rim, or an array of suction cups for picking up an array of one or more boxes for placement on or removal from a pallet stack. In both of these examples, the end-effector is often used by the operator to “adjust” the position of the load it will or is lifting. However, in known intelligent lift devices, the handle(s) which an operator grasps on the end-effector are designed to sense any operator force applied to the handle. This presents a problem of lift movement when the operator is simply applying force to the handle/end-effector in order to position the end-effector or the associated load, without any intention of lifting or lowering the load. This situation is of particular concern when the handle is positioned off-center from the load's center of gravity, because the forces applied by the operator to control or position the load may be misinterpreted as commands by the lift.

The disclosed systems and method improve the pendant or operator interface, and are described relative to a variable velocity, electrically-actuated cable lift, where the transducers employed enable simulating the performance of pneumatic or similar lift mechanisms. The present invention may include a control handle or operator interface device for such a system, where the handle or device employs a linear variable displacement transducer as a substitute for a force-sensing handle, for example as described in U.S. Pat. No. 4,917,360 to Yasuhiro Kojima and U.S. Pat. Nos. 6,386,513 and 6,622,990 to Kazerooni, the disclosures of which are hereby incorporated by reference in their entirety. Such a device may be sold and used in association with a G-Force lift by Gorbel, Inc. as is more specifically set forth in the following figures and detailed description.

Once aspect of the disclosed system is a user interface for a human power amplifier lift, wherein the interface is operatively associated with an end-effector, comprising: a handle to be grasped by a user, said handle being affixed to the end-effector so as preclude movement of the handle relative to the end-effector when the operator applies a force to the handle; at least one operable control located on said handle, wherein said control produces a signal in response to the user's displacement of the control; and a controller, responsive to a signal generated by the operable control, for controlling the operation of a lift as a function of the signal.

Another aspect of the disclosed system is a lift control device, comprising: a handle suitable for at least partial engagement by a hand of a user, said handle being affixed to an end-effector so as preclude movement of the handle relative to the end-effector when the operator applies a force to said handle; at least one operable control positioned relative to said handle, wherein said control produces a variable signal level in response to the amount of displacement of the control; and a controller, responsive to a signal generated by the operable control, for controlling at least one operation of the lift in response to the signal.

A further aspect is a method for controlling a lift device, comprising: providing a handle suitable for at least partial engagement by a hand of a user, said handle being affixed to an end-effector for retaining a load so as preclude movement of the handle relative to the end-effector when the operator applies a force to said handle; generating, in response to displacement of an operable control positioned relative to said handle, a variable signal level in response to the amount of displacement of the control by the user; and controlling at least one operation of the lift in response to the signal.

### BRIEF DESCRIPTION OF THE DRAWINGS

FIG. 1 is a perspective illustration of an embodiment of the present invention in association with an end-effector used to pick up and position items;

FIG. 2 is an assembly drawing of the various components that are employed in an embodiment of the present invention as depicted in FIG. 1; and

FIG. 3 is another assembly drawing illustrating components within the housing of FIG. 2.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DESCRIPTION OF THE PREFERRED EMBODIMENT

For a general understanding of the various embodiments, reference is made to the drawings. In the drawings, like reference numerals have been used throughout to designate identical elements.

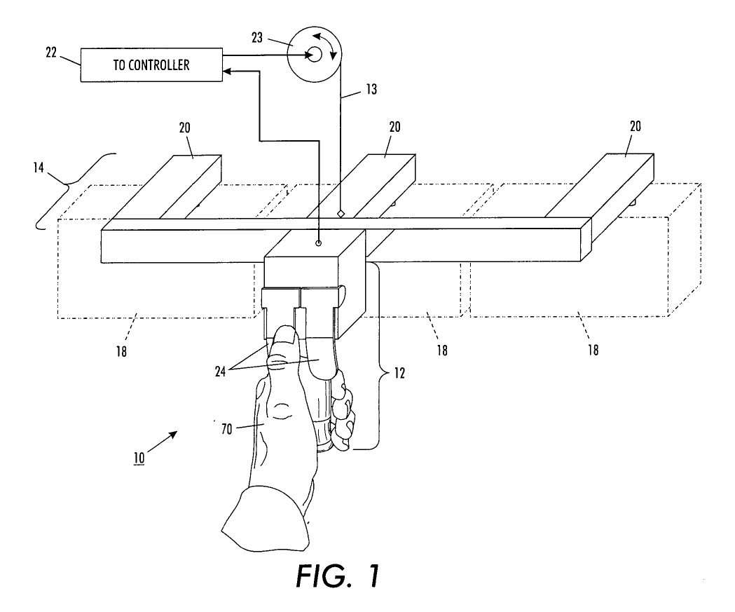

To overcome the disadvantages of particular operating situations as set forth above, the present invention, depicted generally in FIG. 1, provides an operator lift 10 with an interface that employs linear variable displacement transducer (LVDT) technology under the direct control of the operator. More specifically, the interface or handle 12 of lift 10 is attached to a frame or other end-effector assembly 14, where a plurality of boxes or other items 18 may be picked up by suction cups 20 or other gripping and attachment mechanisms on the end-effector. It will be appreciated that for purposes of use and safety, the interface or handle 12 may be positioned at a location that is not coincident with the center-of-gravity of the end-effector. In other words, the user would apply force to the handle 12 to manipulate the end-effector assembly 14.

In use, the handle 12 is used by an operator who grasps the handle and controls the displacement of at least two buttons 24 to raise or lower the cable 13. It will be appreciated that the end-effector may include one or more of many devices or mechanisms such as suction cups, hooks, clamps, forks, etc. that are employed to connect, hold or be inserted under or through the items to be lifted or lowered (e.g., boxes 18). Hence, the present invention is not to be limited in any manner by the type of end-effector employed. It will also be appreciated that the devices employed to connect or hold items may also be controlled by additional buttons or sensors located on or associated with the handle 12 or end-effector assembly 14.

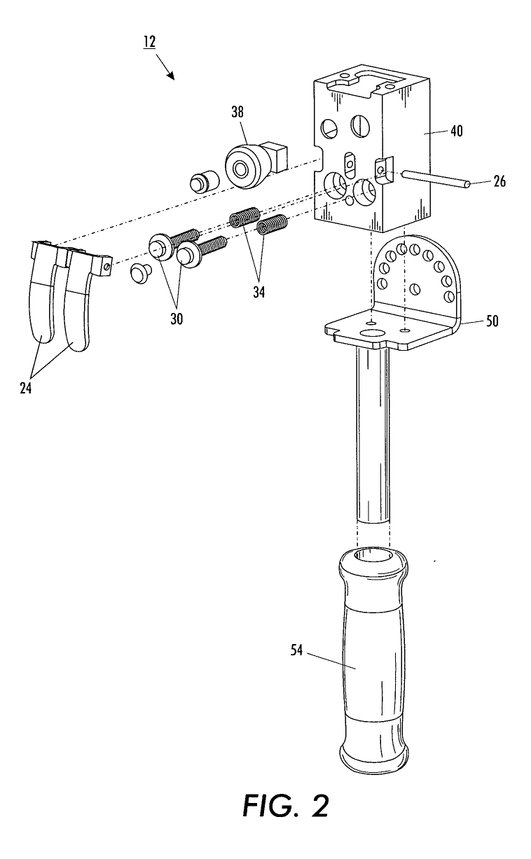

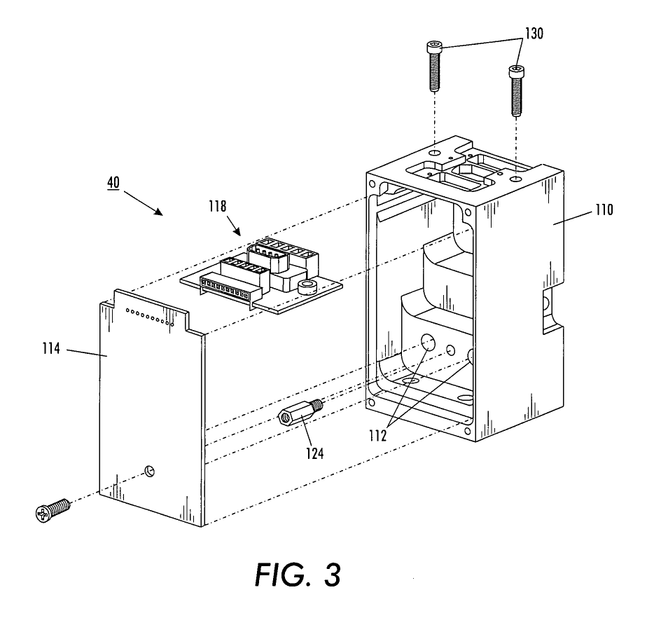

Referring also to FIGS. 2 and 3, the buttons 24 operate LVDTs. In turn, the output of the LVDTs are amplified and/or conditioned and supplied to a controller 22 that processes the LVDT signals to determine the magnitude thereof. In response, the controller generates its own control signals that cause the electrically powered actuator to raise or lower the cable 13 at various speeds, based upon one of the buttons 24 being depressed. For example, when the operator depresses left-most button 24 or any similarly operable control to raise the end-effector and load, the associated LVDT senses the displacement of the button 24 and generates a signal that is proportional to the amount of the displacement. In other words, the LVDT output, and the signal representative thereof, is varying yet proportional to the amount of depression of the button 24—the greater the amount the button is depressed, the greater the magnitude of the signal.

The variable signal generated by the LVDT in response to the button being pressed is then fed to the controller 22, which responds in a manner so as to control the lift speed in response to the magnitude of the signal. Thus, an operator is able to control not only the motion of the lift, but also the speed of the lift—where depressing the button a greater amount results in an increased speed of operation. Also, because the lift 10 is intended to operate in accordance with traditional G-force control systems, further features (e.g., stopping points, lift speed limits, etc.) may be set as well to facilitate use of the lift and LVDT interface in various work environments. Such features are found, for example, in co-pending U.S. patent application Ser. No. 10/777,920 by M. Taylor et al., filed Feb. 12, 2004, the teachings of which are hereby incorporated by reference in their entirety. It will be appreciated that logic or similar controls may be used with or applied to process the signals created by the buttons and LVDTs to interpret signals and control the lift if, for example, both buttons are pushed simultaneously.

As is more specifically illustrated in FIG. 2, the buttons 24 are each pivotally connected to a housing 40 by a pin 26. The buttons come into contact, respectively, with one of a pair of mechanical actuators 30 that are biased away from housing 40 by springs 34. Thus, the buttons are, in turn, biased into a nominal position depicted as away from the housing, and depression of the buttons (moving the end opposite the pivot towards the housing) will cause the actuator to extend into the housing 40. Referring also to FIG. 3, which is an assembly drawing of the reverse side of housing 40, the mechanical actuators extend through holes 112 in box 110 where they are allowed to freely travel through the core of LVDT's 124 and move forward and backward therein in response to a user-applied force and the spring bias force.

The main advantage of the LVDT over other types of switches or displacement transducers is the high degree of robustness. This is derived from the fact that there is no physical contact across the sensing element, so there is zero wear in the sensing element, which also means that LVDTs can be made waterproof and in a format suitable for the most severe environments. The LVDT principle of measurement is based on magnetic transfer, which also means that the resolution of LVDT transducers is essentially infinite. The smallest fraction of movement can be detected by suitable signal conditioning electronics. It is the combination of these factors, plus the accuracy and repeatability that provide the needed operator sensing for the present invention.

The electronic circuit 118 is used to receive the transducer signal and to generate or pass therethrough a signal indicative of the displacement of the actuator 30 and button 24. In this manner, the signal accurately indicates the amount of displacement and is unlike a simple on/off switch. Through the use of a transducer, the displacement is characterized with exceptional accuracy and may be then passed to controller 22 where it is processed as a function of its magnitude to control the speed at which the actuator 23 raises or lowers the cable 13.

In one embodiment, the LVDT's used may be omni-directional transducers capable of sensing a displacement from about 0.015 inches to 0.30 inches in infinitely variable increments or resolution. Although described with respect to a linear displacement transducer, it will be appreciated by those skilled in electronic technology that alternative components may be used to accurately sense the displacement of buttons 24 in the handle 12. For example, it may also be possible to sense the rotation of the button around pin 26 using a rotary capacitive displacement transducer, angular displacement transducer or similar device—again the keys being both the reliability and the non-contact sensing enabled by such displacement transducers and the like.

Referring again to FIGS. 2 and 3, in addition to the LVDT controls as described above, the handle or pendant 12 likely includes a stop button 38, a mounting bracket 50 and an associated grip 54, where the grip 54 is assembled onto the lower, cylindrical portion of bracket 50 and is affixed thereto by mechanical means such as an interference fit, adhesive, etc. In operation, the height of the handle 12 and associated end-effector 20 will be controlled in response to the operator's depressing the buttons 24. Moreover, the stop button and/or an “operator present button” on the grip 54, may be used to over-ride the signals produced in response to an operator's depressing of buttons 24.

Having described the basis components of the lift and associated controls, attention is briefly turned to the method in which such systems are controlled. The method for controlling a lift device includes employing a handle suitable for at least partial engagement by a hand 70 of a user, said handle being affixed to an end-effector for retaining a load. In one sense, the handle and end effector are affixed to one another so as preclude movement of the handle relative to the end-effector (or its associated load) when the operator applies a force to the handle. Next, the system generates, in response to displacement of the operable control or button 24, a variable signal level in response to the amount of displacement of the operable control. Controller 22 then controls at least one operation of the lift (e.g., vertical velocity, braking force, acceleration) in response to the signal. As further described above, the variable signal is generated by a displacement transducer. The displacement transducer (linear or rotational) is operatively associated with the operable control, and the displacement of the control produces the signal in response.

In recapitulation, the present disclosure includes a method and apparatus to provide an improved pendant or operator interface for a variable velocity cable lift. The present invention may be used with an electrically-actuated cable lift, with the intention of simulating the performance of a pneumatic or similar lift mechanism.

It is, therefore, apparent that there has been provided, in accordance with the present disclosure, a method and apparatus for operator control of a variable velocity cable lift. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

1. A user interface for a human power amplifier lift, wherein the interface is operatively associated with an end-effector, comprising:
a handle to be grasped by a user, said handle being affixed to the end-effector so as preclude movement of the handle relative to the end-effector when the operator applies a force to the handle;
at least one operable control located on said handle, wherein said control produces a signal in response to the user's displacement of the control; and
a controller, responsive to a signal generated by the operable control, for controlling the operation of a lift as a function of the signal.

2. The user interface of claim 1, wherein the user interface is positioned at a location that is not coincident with the center-of-gravity of the end-effector.

3. The user interface of claim 1, wherein the operable control includes a displacement transducer, and where said displacement transducer produces a signal in response to a user's displacement of the control.

4. The user interface of claim 3, wherein the displacement transducer is a linear variable displacement transducer.

5. The user interface of claim 3, wherein the displacement transducer is a rotary capacitive displacement transducer.

6. A lift control device, comprising:
a handle suitable for at least partial engagement by a hand of a user, said handle being affixed to an end-effector so as preclude movement of the handle relative to the end-effector when the operator applies a force to said handle;
at least one operable control positioned relative to said handle, wherein said control produces a variable signal level in response to the amount of displacement of the control; and
a controller, responsive to a signal generated by the operable control, for controlling at least one operation of the lift in response to the signal.

7. The lift control device of claim 6, wherein the at least one operation of a lift is the velocity at which the lift operates to change the vertical position of a load supported by the lift.

8. The lift control device of claim 6, wherein the handle is located at a position displaced from the center-of-gravity of the end-effector.

9. The user interface of claim 6, wherein the operable control includes a displacement transducer, and where said displacement transducer produces a signal in response to a user's displacement of the control.

10. The user interface of claim 9, wherein the displacement transducer is a linear variable displacement transducer.

11. The user interface of claim 9, wherein the displacement transducer is a rotary capacitive displacement transducer.

12. A method for controlling a lift device, comprising:
providing a handle suitable for at least partial engagement by a hand of a user, said handle being affixed to an end-effector for retaining a load so as preclude movement of the handle relative to the end-effector when the operator applies a force to said handle;
generating, in response to displacement of an operable control positioned relative to said handle, a variable signal level in response to the amount of displacement of the control by the user; and
controlling at least one operation of the lift in response to the signal.

13. The method of claim 12, wherein the variable signal is generated by a displacement transducer operatively associated with the operable control, and where said displacement produces a signal in response to the user's displacement of the operable control.
